(19) United States
(12) Patent Application Publication
(10) Pub. No.: US 2009/0168642 A1
(43) Pub. Date: Jul. 2, 2009

(54) TELEPHONE SYSTEM, AND NODE DEVICE AND REROUTING METHOD FOR THE SYSTEM

(75) Inventor: Tsutomu Shibata, Hino-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/252,765

(22) Filed: Oct. 16, 2008

(30) Foreign Application Priority Data
Dec. 27, 2007 (JP) 2007-337814

(51) Int. Cl. H04J 3/14; H04L 12/56

(52) U.S. Cl. 370/218; 370/400

(57) ABSTRACT

According to one embodiment of the invention, there is provided a telephone system comprises nodes connected to a first network of a packet exchange type and a second network of a volume-based charging type. The nodes mutually form a communication route. The system comprises terminal devices each connected to any one of the nodes and configured to mutually perform telephone communication via the route. Each of the nodes comprises a detector monitors a state of first network to detect failure in the first network, a reroute processor reroutes a part of the route into second network via a relay node to be an interface between the networks to avoid the detected failure, and a decision processor decides a relay node to minimize a cost required for the route to pass the second network. The reroute processor reroutes the route via the relay node decided by the decision processor.

### CROSS-REFERENCE TO RELATED APPLICATIONS

This application is based upon and claims the benefit of priority from Japanese Patent Application No. 2007-337814, filed Dec. 27, 2007, the entire contents of which are incorporated herein by reference.

### BACKGROUND

1. Field

One embodiment of the present invention relates to a telephone system in which telephone terminals, software-implemented telephones, etc., transmit and receive packets to actualize voice communication, and a node device and a rerouting method for this kind of the system.

2. Description of the Related Art

Systems which establish voice communication via packet exchange type networks have been known. Above all, a system called a Voice over IP (VoIP) using an Internet Protocol (IP) network has come into practical use. The IP is a general-purpose communication protocol in inter-computer communication. Therefore, using an IP telephone system enables flexibly constructing a cooperation function among telephone terminals and computers. In recent years, constructing extension telephone networks by connecting IP telephone sets to local area networks (LANs) in offices has become used. Meanwhile, a volume-based charging type switched network such as a public network and a private telephone network is still the mainstream, and both the IP network and the switched network coexist nowadays.

From the point of view of a communication cost, it is more advantageous for a user to use the IP network. Thus, a configuration, in which the user mainly uses the IP network and reroutes through the switched network on occurrence of a communication failure has become used. Rerouting packet traffic enables maintenance of a telephone connection without interrupting communication.

A technique regarding the rerouting in the packet exchange network is disclosed in any of Jpn. Pat. Appln. KOKAI Publication No. 2002-252634, Jpn. Pat. Appln. KOKAI Publication No. 2003-229890, and Jpn. Pat. Appln. KOKAI Publication No. 2004-248177. However, recent years, a rerouting technique across the packet exchange network and the switched network that are different kinds of networks has been developed, the technique in each of the given references cannot be applied to such a rerouting technique.

A technique in which the IP network and the switched network are connected by a node device, and rerouting across both networks is realized via the node device is known. However, in such a system, a technique for optimizing a communication cost has not been developed. Therefore, long-distance rerouting frequently occurs on the switched network side. Thus, a cost burden on a user is apt to increase. More specifically, in an enterprise user having bases in a plurality of districts, since communication costs increase due to a volume-based charging system, things come into a serious situation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view for explaining rerouting according to the existing technique;

FIG. 2 is a functional block diagram illustrating embodiments of node devices N1-N3 regarding the invention;

FIG. 3 is a schematic view illustrating a relay node decision table 14a in FIG. 2;

FIG. 4 is a view illustrating rerouting by the node devices N1-N3 regarding the invention; and

FIG. 5 is a flowchart illustrating a processing procedure to be performed by the node devices N1-N3 regarding the invention.

### DETAILED DESCRIPTION

Various embodiments according to the invention will be described hereinafter with reference to the accompanying drawings. In general, according to one embodiment of the invention, a telephone system, comprises a plurality of node devices which are connected to a first network of a packet exchange type and a second network of a volume-based charging type and mutually forms a communication route through at least either the first or the second network; and a plurality of terminal devices which are each connected to any one of the node devices and are configured to mutually perform telephone communication via the communication route. Each of the node devices comprises a detection processing module which monitors a state of the first network to detect a failure in the first network, a reroute processing module which reroutes at least a part of the communication route into the second network via a relay node to be an interface between the first and the second networks so as to avoid the detected failure and a decision processing module which decides a relay node to minimize a cost required for the communication route to pass the second network. The reroute processing module reroutes the communication route via the relay node decided by the decision processing module.

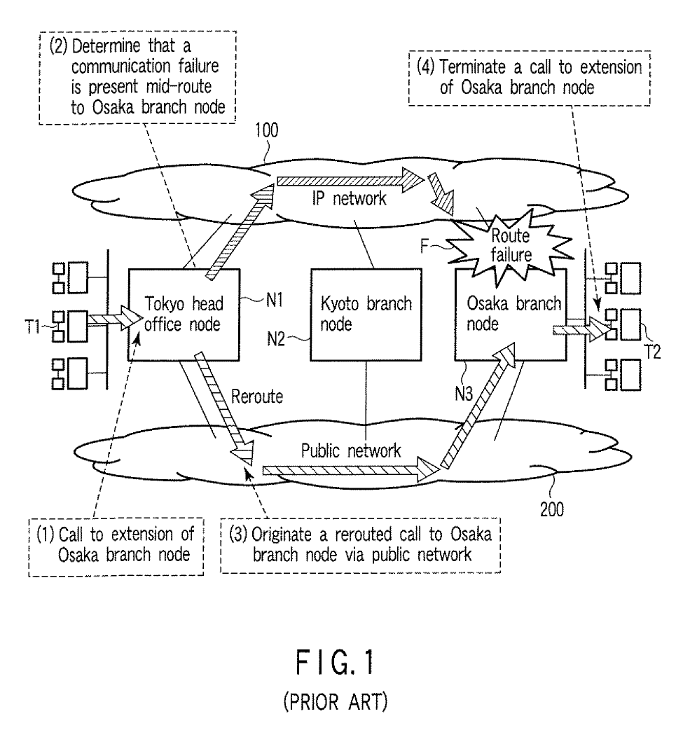

FIG. 1 shows a view for explaining rerouting according to the existing technique. In this embodiment, an IP network 100 is adopted as an example of a packet exchange type network, and a public network 200 is adopted as an example of a volume-based charging type network. Node devices belonging to a telephone system are each connected to the IP network and the public network 200. The node devices accommodate each of a plurality IP terminals as their subordinates. The IP terminal has a voice communication function, and more specifically, has a VoIP communication function communicable through any of the IP network 100 and the public network 200.

It is assumed that each node device belongs to the same company, a Tokyo head office node is designated by a symbol N1, a Kyoto branch office node is designated by a symbol N2, and an Osaka branch office node is designated by a symbol N3. One IP terminal under the Tokyo head office node N1 is designated by a symbol T1 and set to a call origination terminal T1, and one IP terminal under the Osaka branch office node N3 is designated by a symbol T2 and set to a call termination terminal T2.

In FIG. 1, each node N1-N3, for example periodically monitors the IP network 100, and detects the presence or absence of a failure. In FIG. 1, it is assumed that a route failure F occurs at a spot (e.g., a router [not shown]) connecting the IP network 100 to the Osaka branch office node N3 and any of the nodes N1-N3 have already detected the failure. As regards the route failure F, any one of communication blackout, link disconnection, delay, throughput deterioration, exceeded bandwidth, or a combination thereof.

It is assumed that a call origination is generated from the call origination terminal T1 to the call termination terminal T2 through an extension. Then, according to the existing technique, the node N1 blindly forms a communication route going thorough a public network 200 in all sections without taking the use of the IP network 100 into account. Thereby, although a communication service can be continued, a communication cost is raised due to the volume-based charging in the public network 200. That is, (1) in response to an extension calling from the call origination terminal T1, (2) the node N1 determines that a communication failure is present, (3) and reroutes a call to the node N3 through the public network 200. Then, (4) the call arrives at an extension of the node N3, namely the call termination terminal T2; however, the company bears a heavy cost burden. An embodiment capable of solving such a situation will be described.

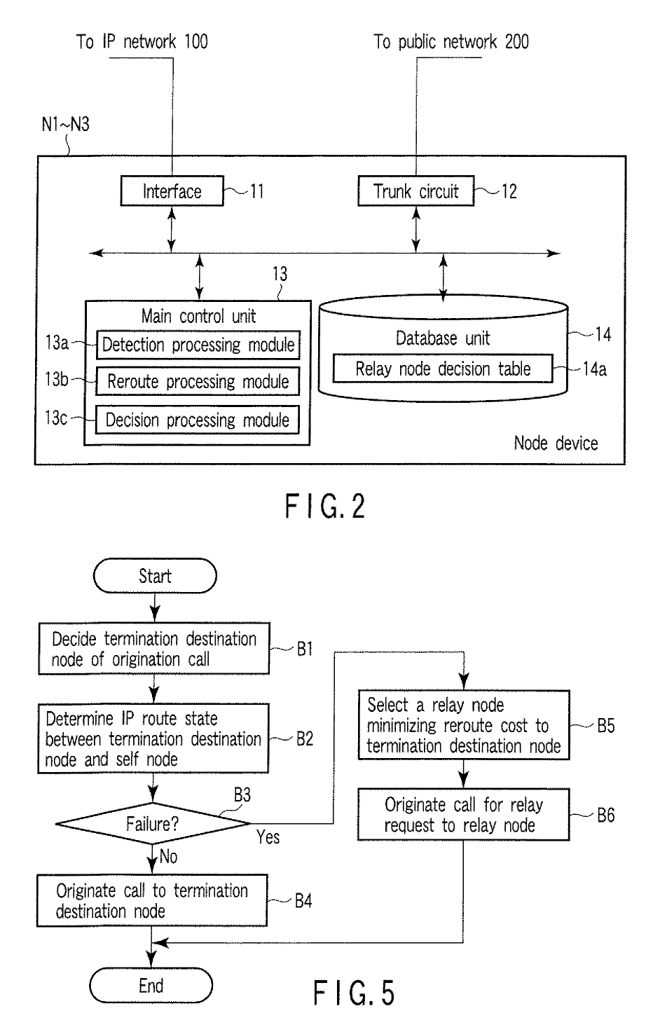

According to an embodiment, FIG. 2 shows a functional block diagram illustrating an embodiment of the node devices N1-N3. Each node device N1-N3 includes an interface unit 11, a trunk circuit 12, a main control module 13 and a database unit 14. The interface unit 11 is connected to the IP network 100 and takes on processing regarding transmission and reception of packets. The trunk circuit 12 is connected to the public network 200 and takes on interface processing to and from the public network 200, encapsulation of packets, decapsulation of packets, etc.

The main control module 13 includes a detection processing module 13a, a reroute processing module 13b, and a decision processing module 13c as a processing function regarding the embodiment. A detection processing module 13a periodically or non-periodically monitors the state of the IP network 100 by sequential polling or real time polling to detect a route failure.

A reroute processing module 13b reroutes at least a part of a communication route to a public network side 200 so as to avoid the detected failure for forming the communication route. A node device to be a boundary (interface) between the IP network 100 and the public network 200 is referred to as a relay node. The decision processing module 13c decides a node device to be a relay node for each communication route.

More specifically, the decision processing module 13c decides the relay node so as to the cost when the communication route pass through the public network 200 becomes minimized. At this time, the decision processing module 13c refers a relay node decision table 14a stored in the database 14 to obtain an index for deciding the relay node. The reroute processing module 13b reroutes the communication route so as to go through the relay node decided by the decision processing module 13c.

The various modules of the systems described herein can be implemented as software applications, hardware and/or software modules, or components on one or more computers, such as servers. While the various modules are illustrated separately, they may share some or all of the same underlying logic or code.

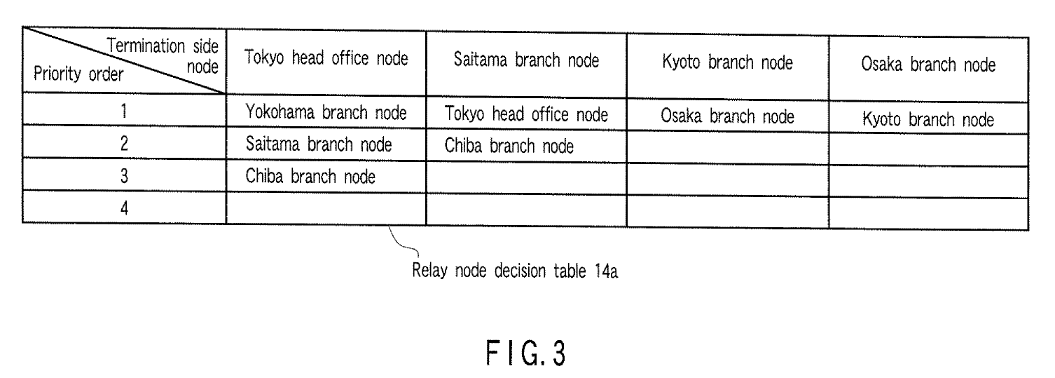

FIG. 3 shows a schematic view illustrating the relay node decision table 14a. The decision table 14a is a table wherein node devices to be candidates of relay nodes are associated with their priority order for each node device and described in a form of a table. That is, the decision table 14a is a table wherein when nodes controlling call termination terminals as subordinates are set as termination side nodes, arranges other terminals to make relay nodes by giving a priority order for each termination side node. The decision table 14a is prepared in advance and stored in each node device.

In FIG. 3, for example, if the node N1 is a termination side node, a first order candidate of the relay node is a Yokohama branch node, a second order candidate is a Saitama branch node, and a third candidate node is a Chiba branch node (any of them are not shown). An index deciding priority order is mainly a distance between a relay node and a termination side node; in short, the decision table 14a may give higher priority order to the nodes with low communication costs in the ascending order of the priority. For deciding a relay route, the decision processing module 13c decides relay nodes in the descending order of the priority for the termination side node. The following will describe operations of the telephone system configured as given above.

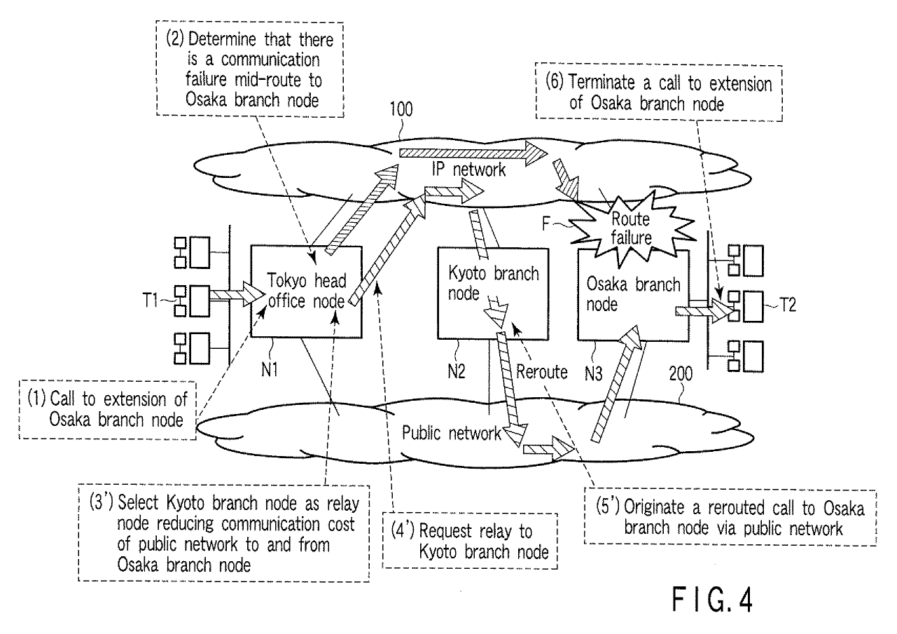

FIG. 4 shows rerouting by the node devices N1-N3 of the embodiment. In FIG. 4, the Tokyo head office node N1 which has received an extension call origination (1) from the call origination terminal T1 determines existence of the communication failure (2).

Then, the node N1 selects a relay node capable of decreasing a communication cost of the public network 200 between the node N1 and the node N3. At this time, the node N1 refers to the decision table 14a of FIG. 3. The node N1 selects a relay node which decreases a communication cost for rerouting to the Osaka branch node N3 and in which the IP route failure does not occur in accordance with the priority order in the decision table 14a (3′). Here, it is assumed that that the Kyoto branch node N2 has been selected. The node N2 is the node which reduces the communication cost to a minimum for rerouting the public network 200 to and from the node N3. The node N1 makes the node N2 a request to relay a voice call (4′).

When receiving the voice call, the node N2 reroutes a call to the node N3 through the public network 200 (5′). Like this, a call from the call origination terminal T1 terminates through an extension to the termination call terminal T2 under the node N3 via a communication route partially rerouting into the public network 200 (6).

FIG. 5 shows a flowchart in which the aforementioned processing procedures. When a call origination is generated from the IP terminal of the extension, a node device (origination side node) under which the call origin terminal is controlled decides a termination destination node of the call origination (Block B1). Next, the call origination side node determines a state of a route in an IP network to and from the call termination destination node (termination side node) (Block B2). If no failure is present on the route of the IP network 100 (NO, Block B3), the origination side node originates a call to the termination side node (Block B4), and a communication route passing through the IP network 100 is formed.

When a failure is detected in Block B3, the origination side node selects relay nodes by which the rerouting cost to the determination side node becomes minimized (Block B5), and originates a call for making the selected relay node a request for relay (Block B6). The communication route formed as given above, although partially passes through the public network 200, the communication cost is minimized.

As mentioned above, in this embodiment, each node N1-N3 detects the IP route failure to and from other nodes devices to store the failure. If the IP route failure is present between the origination side node and the termination side node, the origination side node selects candidates of a plurality of relay nodes which can be the rerouting nodes to the public network 200. The origination side node selects the relay node by which the rerouting cost to the public network 200 becomes minimized. The origination side node establishes a communication route via the IP network 100 to the selected relay node, and the relay node reroutes communication to the termination side node through the public network 200.

Since the telephone system is configured as given above, the system enables to dynamically decide the relay node which makes the communication cost minimum for rerouting. Rerouting from the relay nodes decided as mentioned above enables providing a solution to minimize total communication cost. Thus, a telephone connection service may be continuously provided while the communication cost is suppressed.

The invention is not limited to the foregoing embodiment. For instance, in the embodiment, the failure in the IP network 100 is monitored by means of real time polling or sequential polling. As a substitution for this, failure detection processing may be started by the generation of the call origination from the origination side terminal T1 as a trigger. Such starting enables traffic for detecting a failure to be minimized, and a burden on network resources may be reduced.

While the embodiment has decided the relay node by referring to the decision table 14a, the invention is not limited to this way of decision; the telephone system may calculate a required cost between the origination side and the termination side nodes on the basis of a rate system of the public network 200, and select the relay node by which the calculated cost is minimized.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system, comprising:
a plurality of node devices which are connected to a first network of a packet exchange type and a second network of a volume-based charging type and mutually forms a communication route through at least either the first or the second network; and
a plurality of terminal devices which are each connected to any one of the node devices and are configured to mutually perform telephone communication via the communication route, wherein
each of the node devices comprises:
a detection processing module which monitors a state of the first network to detect a failure in the first network;
a reroute processing module which reroutes at least a part of the communication route into the second network via a relay node to be an interface between the first and the second networks so as to avoid the detected failure; and
a decision processing module which decides a relay node to minimize a cost required for the communication route to pass the second network, and
the reroute processing module reroutes the communication route via the relay node decided by the decision processing module.

2. The telephone system of claim 1, wherein
the detection processing module periodically monitors the state of the first network.

3. The telephone system of claim 1, wherein
the detection processing module monitors the state of the first network in response to call origination from the terminal devices.

4. The telephone system of claim 1, wherein
the decision processing module calculates the cost on the basis of a rate system of the second network to decide the relay node on the basis of the calculation result.

5. The telephone system of claim 1, further comprising:
a management table wherein node devices to be candidates of relay nodes are associated with priority order for each of the plurality of node devices and described in a form of a table, wherein
the decision processing module decides the relay node on the basis of the priority order of node device to be managed by the management table.

6. A node device for use in a telephone system, comprising a plurality of node devices which are connected to a first network of a packet exchange type and a second network of a volume-based charging type and mutually forms a communication route through at least either the first or the second network; and a plurality of terminal devices which are each connected to any one of the node devices and are configured to mutually perform telephone communication via the communication route, the node device comprising:
a detection processing module which monitors a state of the first network to detect a failure in the first network;
a reroute processing module which reroutes at least a part of the communication route to the second network via a relay node to be an interface between the first and the second networks so as to avoid the detected failure; and
a decision processing module which decides a relay node to minimize a cost required for the communication route to pass the second network, wherein
the reroute processing module reroutes the communication route via the relay node decided by the decision processing module.

7. The node device of claim 6, wherein
the detection processing module periodically monitors the state of the first network.

8. The node device of claim 6, wherein
the detection processing module monitors the state of the first network in response to a call origination from the terminal device.

9. The node device of claim 6, wherein
the decision processing module calculates the cost on the basis of a rate system of the second network to decide the relay node on the basis of the calculation result.

10. The node device of claim 6, further comprising:
a management table wherein node devices to be candidates of relay nodes are associated with priority order for each of the plurality of node devices and described in a form of a table.

11. A rerouting method for use in a telephone system, comprising a plurality of node devices which are connected to a first network of a packet exchange type and a second network of a volume-based charging type and mutually forms a communication route through at least either the first or the second network; and a plurality of terminal devices which are each connected to any one of the node devices and are configured to mutually perform telephone communication via the communication route, the method comprising:
a detection step of monitoring a state of the first network to detect a failure in the first network;
a rerouting step of rerouting at least a part of the communication route to the second network via a relay node to be an interface between the first and the second networks so as to avoid the detected failure; and
a decision step of deciding a relay node to minimize a cost required for the communication route to pass the second network, wherein
the rerouting seep reroutes the communication route via the relay node decided by the decision step.

12. The method of claim 11, wherein
the detection step is a step of periodically monitoring a state of the first network.

13. The method of claim 11, wherein
the detection step is a step of monitoring a state of the first network in response to a call origination from the terminal device.

14. The method of claim 11, wherein
the decision step is a step of calculating the cost on the basis of a rate system of the second network to decide the relay node on the basis of the calculation result.

15. The method of claim 11, wherein
the decision step is a step of deciding the relay node on the basis of the priority order of node devices to be managed in a management table wherein node devices to be candidates of relay nodes are associated with priority order for each of the plurality of node devices and described in a form of a table.
